(19) United States
(12) Patent Application Publication
(10) Pub. No.: US 2012/0291194 A1
(43) Pub. Date: Nov. 22, 2012

(54) STEAM GENERATOR FOR SAUNA

(76) Inventor: Seung Woo LEE, Yorba Linda, CA (US)

(21) Appl. No.: 13/230,606

(22) Filed: Sep. 12, 2011

(30) Foreign Application Priority Data
Sep. 13, 2010 (KR) 10-2010-0089646

(51) Int. Cl. A61H 33/06

(52) U.S. Cl. 4/524

(57) ABSTRACT

A steam generator for sauna device enabling a steam sauna in a sauna room, the steam generator comprising: a water tank; a steam tank with a heating device for heating water and generating steam, and a steam releasing hole for supplying steam to an external sauna room; a connecting tube installed between the water tank and the steam tank; and an air pressure equalizing tube installed between the water tank and the steam tank for a path for the steam in the steam tank to move into water of the water tank equalizing air pressure of the steam tank and the water tank. The heating device can generate steam rapidly with less energy and increases the thermal efficiency.

### BACKGROUND OF THE INVENTION

The present invention relates to a steam generator for sauna, and more specifically to a steam generator for sauna device, which is installed in a sauna device, and generates and supplies steam.

Recently, steam sauna facilities have been introduced widely for shower device as an appliance as well as for bath, and used in apartments, officetels, condos, dorms, hospitals, etc. as well as single-family house.

The above steam sauna provides a steam generator which supplies steam of an appropriate temperature to a sauna room manufactured in a predetermined size, such that by applying the steam directly to a body or having the steam absorbed through skin the skincare is facilitated and by increasing the blood circulation and facilitating the metabolism the body health can be helped out.

One of such steam generator of prior arts is disclosed in the Korean patent 10-0531978, which discloses a steam tank for storing water, a heating device installed in the steam tank for heating water, a water level measuring structure for measuring the level of water in the steam tank, a water tank for supplying water to the steam tank, a steam releasing hole for guiding steam generated in the steam tank, a venting tube installed in the steam tank for guiding and venting steam to outside, an electronic opening/closing valve installed in the venting tube and connected to the water level measuring structure for opening/closing the inside of the venting tube so as to releasing the pressure in the steam tank to outside, a steam exchanger installed in the venting tube for cooling the hot steam, a condensate container enclosing the steam exchanger, and a pressure measuring structure installed in the steam tank for measuring internal pressure.

The above steam generator, in which when the water level in the steam tank is a predetermined low level the remnant pressure in the steam tank is released completely automatically through the opening/closing valve operating in a link with the water level measuring structure, such that even in the case of a low place of a weak water pressure or supplied water of low pressure the water is compensated easily so as to prevent delay of operation or overheating of the device.

However, in the case of the above steam generator, since water and steam heated in the steam tank by the heating device are delivered directly to the water level measuring structure, there are problems that when used for a long time the water level measuring structure may malfunction or be damaged due to the high temperature. Also, the heating device may generate vibration while heating water, such that the water level measuring structure shakes consistently due to the vibration, loosening its fastening portions. Additionally, since the cold water introduced from the water tank meets with the water heated by the heating device, it takes long in order for the heating device to generate steam.

And, there is a problem that the thermal efficiency tends to be low since when the venting tube is opened to remove the internal pressure, the steam as well as the internal pressure are released.

Accordingly, a need for a steam generator for sauna device has been present for a long time considering the expansive demands in the everyday life. This invention is directed to solve these problems and satisfy the long-felt need.

### SUMMARY OF THE INVENTION

The present invention contrives to solve the above disadvantages of the prior art and to provide a steam generator for sauna device, which keeps the internal pressure of water tank and steam tank through an air pressure equalizing tube, shortens the time for steam generation with less energy by preheating water in the water tank by means of steam, and increases the thermal efficiency.

For the above purposes, a steam generator for sauna device enabling a steam sauna in a sauna room comprises: a water tank for storing water; a steam tank comprising a heating device installed so as to heat water inside and generate steam and a steam releasing hole provided so as to supply the generated steam to an external sauna room; a connecting tube installed between the water tank and the steam tank for providing a path for water flowing from the water tank to the steam tank; an air pressure equalizing tube installed between the water tank and the steam tank so as to provide a path for the steam in the steam tank to move into water of the water tank and equalizing air pressure of the steam tank and the water tank.

Also, the steam generator according to the present invention further comprises: a water level sensor installed in the water tank for measuring water level; a water supplying tube connected to the water tank for supplementing water in the water tank and installed with a first electronic opening/closing valve so as to cooperate with the water level sensor and control electronically water flow into the water tank; and a venting tube installed in the water tank so as to provide a path for venting air in the water tank to outside and installed with a second electronic opening/closing valve so as to cooperate with the water level sensor and control electronically air flow from the water tank.

Also, the steam generator according to the present invention further comprises a temperature sensor installed in the steam tank so as to be positioned in the water level of the steam tank corresponding to the water level of the water tank.

In a steam generator according to the present invention, a heating device in a steam tank can generate steam rapidly with less energy and increases the thermal efficiency since the steam of the steam tank is configured to move over to a water tank through an air pressure equalizing tube and preheat water in the water tank by the steam.

Also, it is easy to use because it is possible to control stably water introduction and steam venting by a water level sensor installed in the water tank and an electronic opening/closing valve cooperating with it, and the user does not have to supply water manually.

Also, malfunction of auxiliary devices can be prevented in advance by preventing overheating of the heating device through a temperature sensor installed in the steam tank and preventing the steam tank overheated by heating of air in the heating device from damaging the auxiliary devices.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view of a steam generator for sauna device according to the invention;

FIG. 2 is a cross-sectional view showing a steam generator for sauna device with parts removed;

FIG. 3 is a cross-sectional view showing a steam generator for sauna device of FIG. 2 according to another embodiment of the present invention;

FIG. 4 is a view showing a temperature sensor of a steam generator for sauna device according to the invention;

FIG. 5a is an exemplary view showing a steam generator for sauna device with parts removed;

FIG. 5b is a view of FIG. 5a according to another embodiment of the present invention;

FIG. 6 is a block diagram showing relationship among components in a steam generator for sauna device according to the present invention; and

FIG. 7 is a view showing how to use a steam generator for sauna device according to the present invention.

### DETAILED DESCRIPTION EMBODIMENTS OF THE INVENTION

This application claims priority to Korean Patent App. Ser. No. 10-2010-0089646 filed Sep. 13, 2010, all of which are hereby incorporated by reference.

Below, a steam generator for sauna device according to the invention is described in detail referring to the figures.

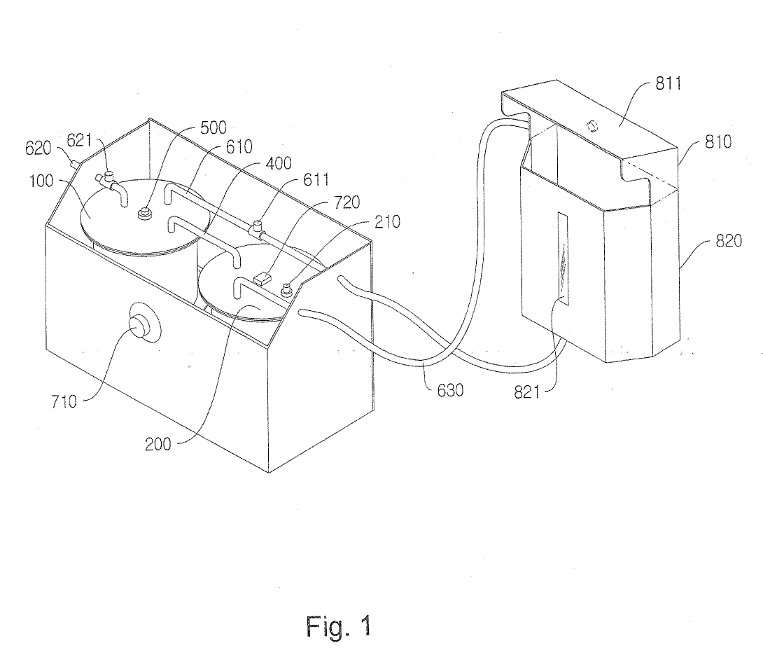

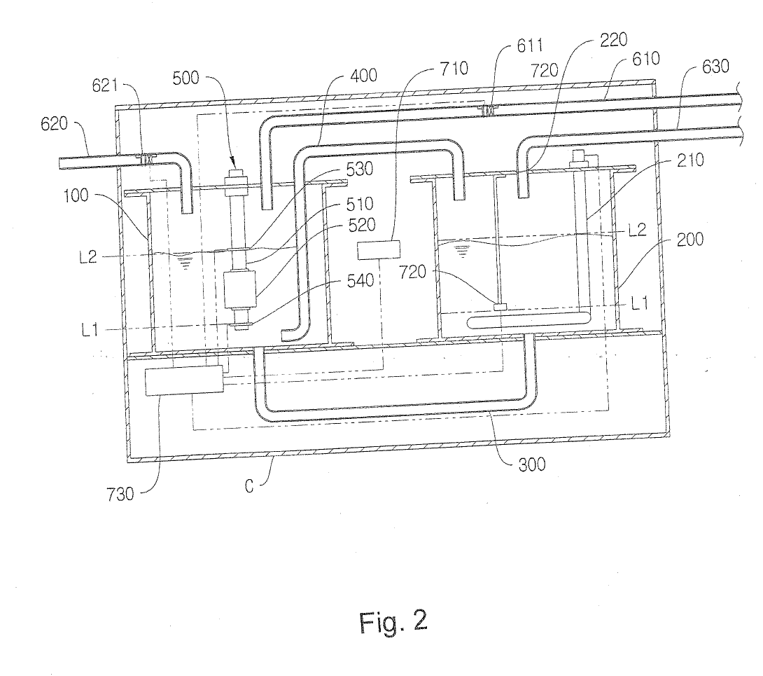

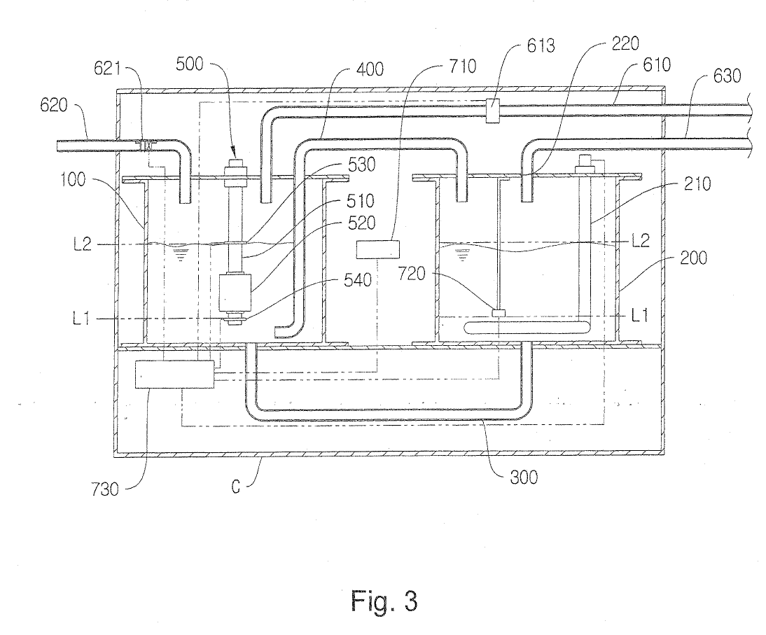

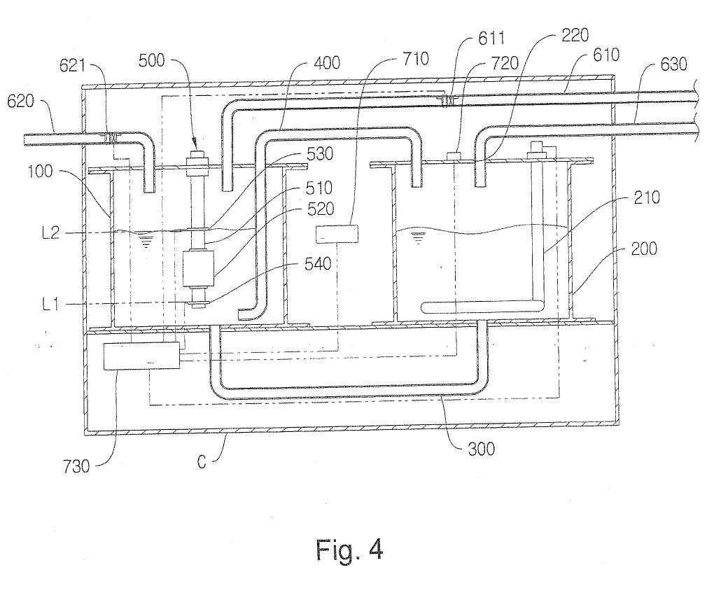

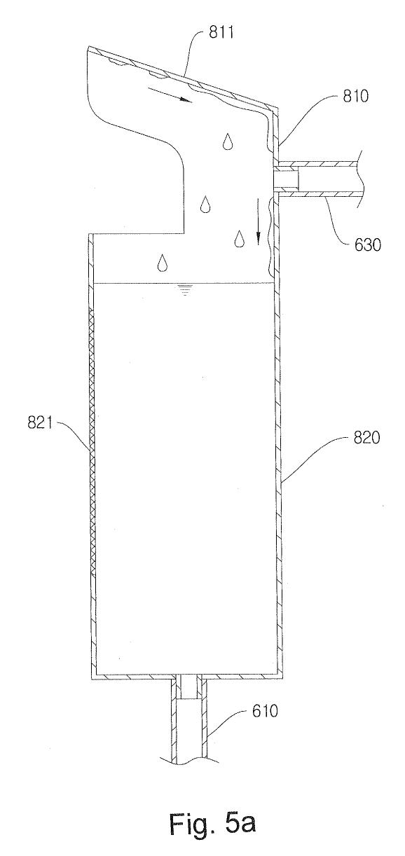

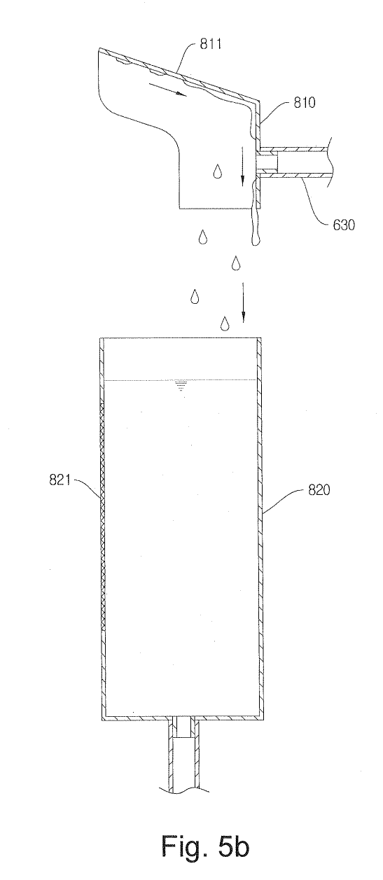

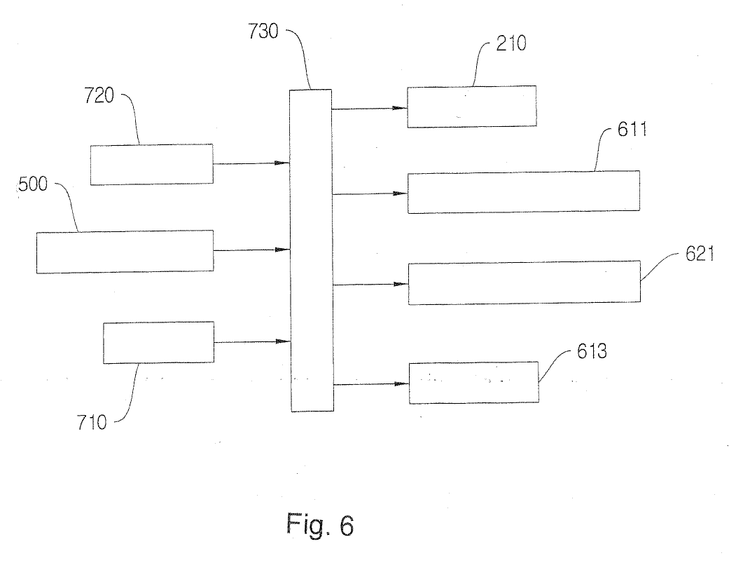

FIG. 1 is a perspective view of a steam generator for sauna device according to the invention, FIG. 2 is a cross-sectional view showing a steam generator for sauna device with parts removed, FIG. 3 is a cross-sectional view showing a steam generator for sauna device of FIG. 2 according to another embodiment of the present invention, FIG. 4 is a view showing a temperature sensor of a steam generator for sauna device according to the invention, FIG. 5a is an exemplary view showing a steam generator for sauna device with parts removed, FIG. 5b is a view of FIG. 5a according to another embodiment of the present invention, and FIG. 6 is a block diagram showing relationship among components in a steam generator for sauna device according to the present invention.

Referring to FIG. 1, a steam generator for sauna device according to an embodiment of the present invention comprises a water tank (100), a steam tank (200), and a water supply (820). Here, the water tank (100) and the steam tank (200) are located in a case (C) so as to be fixed together in a sauna room (10).

Referring to FIGS. 2 and 3, the water tank (100) has a sealed internal structure for storing water, and preferably is made of metal such as stainless, which is strong against heat and corrosion.

The steam tank (200) has a sealed internal structure for storing water, and preferably is made of metal such as stainless, which is strong against heat and corrosion. And, in the steam tank (200) is installed a heating device (210) for receiving electrical power from a power source and heating. Here, the heating device (210) is a device for heating water stored in the steam tank (200) and generating steam. Also, on a top surface of the steam tank (200) is formed a steam venting portion (220), which is connected to outside and releases steam generated by the heating device (210). Here, to the steam venting portion (220) is connected an end of a steam delivering tube (630), which will be described later.

The water tank (100) and the steam tank (200) are connected to connecting tube (300) such that water can flow in a lower portion. Here, the connecting tube (300) provides a path for flowing water from the water tank (100) to the steam tank (200), the water flows due to the air pressure difference between the insides of the tanks, and since the water vaporizes in the steam tank (200) and is vented out to outside the water can move from the water tank (100) to the steam tank (200). Therefore, by the inter-connected connecting tube (300), the water stored in the water tank (100) and the steam tank (200) always keep the same height.

A air pressure equalizing tube (400) is installed between the water tank (100) and the steam tank (200), more preferably, an end penetrates the top surface of the water tank (100) and is extended to the floor, and the other end communicates with the top surface of the steam tank (200). Here, the air pressure equalizing tube (400) makes the air pressure increasing naturally with rising of the temperature of the steam tank (200) in level with the water tank (100) through the air pressure equalizing tube (400), preventing back flow of water due to the increase of internal pressure of the steam tank (200). Thus, by installing the air pressure equalizing tube (400) between the water tank (100) and the steam tank (200), the water stored in the water tank (100) can be supplied naturally to the steam tank (200), and the steam in the steam tank (200) can be moved to the water tank (100) through the air pressure equalizing tube (400), such that the water in the water tank (100) may be preheated more or less by the steam.

Referring to FIGS. 2 and 3, in the water tank (100) is installed a water level sensor (500) for measuring water level in the water tank (100), and on the top surface are installed the water supplying tube (610) and a venting tube (620) that is connected to inside.

The water level sensor (500) is a sensing means for sending the water lever mechanically. Here, the water level sensor (500) comprises: a supporting pole (510) installed in the water tank (100); a buoying body (520) installed on the supporting pole (510) slidably; and first and second limit switches (530, 540) which is operated by the buoying body (520) and outputs signals for full or low water, and the water level sensor (500) is connected with a controller (730) installed in the case (C) through wires.

The water supplying tube (610) is connected to the water tank (100) for supplementing water into the water tank (100). And, in the water supplying tube (610) is installed a first electronic opening/closing valve (611), which cooperates with the water level sensor (500) and controls electronically the flow of water supplied to the water tank (100).

The venting tube (620) is installed in the water tank (100) so as to provide a path for venting air in the water tank (100) to outside. And, in the venting tube (620) is installed a second electronic opening/closing valve (621), which cooperates with the water level sensor (500) and controls electronically the flow of air vented from the water tank (100).

On the other hand, FIG. 3 is another embodiment of FIG. 2, and the overall structure is same as described in the above, but instead of the first electronic opening/closing valve (611) installed in the water supplying tube (610) is installed a water supplying pump (613) for pumping water forcibly. Here, the water supplying pump (613) pumps water stored in the water supply (820) and delivers it to the water tank (100).

Referring to FIGS. 2 and 3, in the case (C) described in the above is installed a console (710) for setting a limit temperature, and the console (710) is connected to a controller (730) by wires. And, in the steam tank (200) is installed a remote temperature sensor (720) such as a radiation temperature sensor or an IC temperature sensor. The temperature sensor (720) is installed by means of a bracket having a shape of “u”, more specifically, an end of the u-shaped bracket is fixed to the top surface of the steam tank (200) and the temperature sensor (720) is installed on the other end extending vertically. The temperature sensor (720) is installed to be positioned at a low level (L1) of the steam tank (200) corresponding to the low level (L1) of the console (710), and is connected to the controller (730) by wires. According to the embodiment, if the water in the steam tank (200) is vaporized by the heating device (210), the heating device (210) is exposed on the surface of water, and then the temperature sensor (720) senses the fast-increasing temperature and delivers the temperature value to the controller (730), and then the controller (730) receiving the temperature value from the temperature sensor (720) compares it with a predetermined value and if it exceeds the predetermined value the controller (730) blocks the power supply to the heating device (210). Therefore, using the temperature sensor (720) the overheating of the steam tank (200) due to overheating of the heating device (210) can be prevented, and damaging or malfunctioning of the auxiliary device due to the overheating of the steam tank (200) can be prevented in advance.

FIG. 4 is an embodiment showing another installation of the temperature sensor (720), and if the temperature sensor (720) in FIGS. 2 and 3 is remote-type, the temperature sensor (720) in FIG. 4 is a contact-type temperature sensor such as a platinum resistance temperature detector or thermo couples. Here, the temperature sensor (720) is attached on an outer surface of the steam tank (200), preferably on a top surface of the steam tank (200) and measures the surface temperature of the steam tank (200).

Referring to FIG. 5a, to the water tank (100) and the steam tank (200) are connected a water supply (820) and the steam disperser (810), respectively through the water supplying tube (610) and the steam delivering tube (630), and the steam disperser (810) and the water supply (820) are installed on a wall surface of the sauna room (10).

The steam delivering tube (630) is installed in the steam venting portion (220) of the steam tank (200). Here, the steam delivering tube (630) provides a path for the steam to move.

The steam disperser (810) includes a steam-emitting surface (811) tilting upward, is connected to the steam delivering tube (630) and guides the steam vented from the steam tank (200) to be dispersed into the sauna room (10).

The water supply (820) is installed in a lower portion of the steam disperser (810) such that the water condensated through the steam-emitting surface (811) falls down and is retrieved. Here, the water supply (820) is connected to the water tank (100) by means of the water supplying tube (610) to supplement water. In the case of the embodiment, the water stored in the water supply (820) is installed on a bottom surface of the water supply (820) through the air pressure equalizing tube (400) so as to be supplied to the water tank (100) by gravity. And, in the water supply (820) is installed a checking window (821) having a transparent material such that the user can check the level of water stored in the water supply (820) with bare eyes.

On the other hand, FIG. 5b which is another embodiment of FIG. 5a shows that the steam disperser (810) and the water supply (820) may be formed as one body, but still can be formed separately according to purposes. For example, in a case that the water supply (820) is installed at a same level as or lower than the water tank (100), since the water stored in the water supply (820) is hard to move to the water tank (100) naturally, it is preferable that the water tank (100) may be connected to the water supply (820) through the air pressure equalizing tube (400) with a pump (613) embedded, enabling forced water supplying.

Referring to FIG. 6, the inter-relationship between the components is described below.

The water stored in the water tank (100) and the steam tank (200) keeps a same level initially and then gets reduced little by little as the heating device (210) of the steam tank (200) boils the water, and when the buoying body (520) of the water level sensor (500) falls down little by little and reaches the low level (L1) finally it pushes down the second limit switch (540). And, the second limit switch (540) is operated by the buoying body (520), outputs a low-level signal so as to be delivered to the controller (730), and on receiving the low-level signal the controller (730) controls the first and second electronic opening/closing valves (611, 621) installed in the water supplying tube (610) and the venting tube (620) respectively to open them simultaneously. Thus, by the opening of the first electronic opening/closing valve (611) the water is supplied from the water supply (820) into the water tank (100), and by the opening of the second electronic opening/closing valve (621) the air pressure and the air are released from the water tank (100) to outside such that the inner pressure of the water tank (100) becomes balanced with the atmospherical pressure, facilitating the supply of water from the water supplying tube (610). Also, if the buoying body (520) rises due to the water supplied to the water tank (100), reaches the full level (L2), and then pushes the second limit switch (530), the second limit switch (530) outputs a full-level signal to the controller (730), and on receiving the full-level signal the controller (730) controls the first and second electronic opening/closing valves (611, 621) installed in the water supplying tube (610) and the venting tube (620) respectively to close them simultaneously so as to stop introducing water into the water supply (820) and releasing air to outside.

On the other hand, if the water stored in the steam tank (200) evaporates by the heating device (210) and the heating device (210) is exposed over the water surface, the heat of high temperature is obtained, gets sensed (measured) by the temperature sensor (720) installed in the low-level (L1) of the steam tank (200) and delivered to the controller (730), and then the controller (730) compares the measured value delivered from the temperature sensor (720) with a predetermined value, and blocks power to the heating device (210) by controlling the heating device (210) when the temperature is higher than the predetermined value. And, if the surface temperature of the steam tank (200) falls down below another predetermined value, the temperature sensor (720) controls to supply power to the heating device (210). Therefore, with the above structures, the problem of fire damage to the user or the device by overheating or malfunction can be prevented.

The installation and operation of the present invention having the above structures are described below.

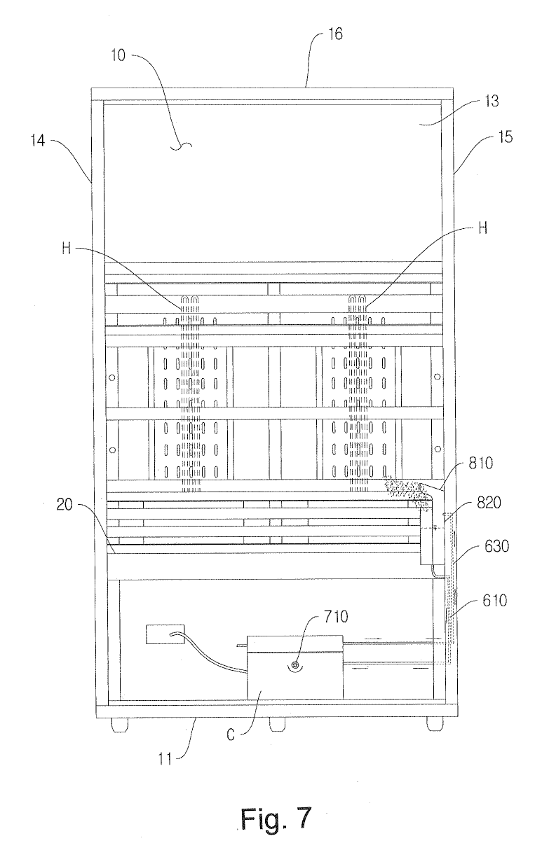

First of all, referring to FIG. 7 for installation, preferably, the steam generator according to the present invention is installed in the sauna room (10), the case (C) is installed in the chair (20) so as to be invisible to the user who enters the sauna room (10), the steam disperser (810) and the water supply (820) are installed on a left plate (14) or a right plate (15) which form the wall, the water supplying tube (610) and the steam delivering tube (630) interconnecting the water tank (100) and the water supply (820), and the steam tank (200) and the steam disperser (810) are embedded in the wall where the steam disperser (810) and the water supply (820) are installed, so as not be exposed to outside.

If applying power in the above state, the pole heater (H) installed in the rear plate (13) is heated with the power and emits the radiation heat to the sauna room (10), the heating device (210) in the steam tank (200) is also heated with the power, heats the water stored in the steam tank (200), and generates steam.

The steam generated by the heating device (210) of the steam tank (200) is delivered to the steam disperser (810) through the steam delivering tube (630), and the delivered steam is emitted into the sauna room (10) along the steam-emitting surface (811). Thus, the user in the sauna room (10) may enjoy sauna with the radiation heat and steam.

On the other hand, the water stored in the water tank (100) is supplied to the steam tank (200) ceaselessly; if the water is vaporized by the heating device (210) and exhausted, the buoying body (520) of the water level sensor (500) imbedded in the water tank (100) falls down and pushes the second limit switch (540) reaching the low-level (L1). Then a low-level signal is generated from the second limit switch (540) and deliver to the controller (730); on receiving the low-level signal the 730 controls the first and second electronic opening/closing valves (611, 621) installed in the water supplying tube (610) and the venting tube (620) respectively to open them simultaneously. Then, by opening of the first electronic opening/closing valve (611) the water stored in the water supply (820) is introduced to the water tank (100) through the water supplying tube (610), and by opening of the second electronic opening/closing valve (621) the internal pressure and air in the water tank (100) are released to outside, obtaining an equilibrium with the atmospheric pressure.

On the other hand, if the buoying body (520) rises due to the water supplied to the water tank (100), reaches the full level (L2), and then pushes the second limit switch (530), the second limit switch (530) outputs a full-level signal to the controller (730), and on receiving the full-level signal the controller (730) controls the first and second electronic opening/closing valves (611, 621) installed in the water supplying tube (610) and the venting tube (620) respectively to close them simultaneously so as to stop introducing water into the water supply (820) and releasing air to outside.

On the other hand, if the water stored in the steam tank (200) evaporates by the heating device (210) and the heating device (210) is exposed over the water surface, the heat of high temperature is obtained, gets sensed (measured) by the temperature sensor (720) installed in the low-level (L1) of the steam tank (200) and delivered to the controller (730), and then the controller (730) compares the measured value delivered from the temperature sensor (720) with a predetermined value, and blocks power to the heating device (210) by controlling the heating device (210) when the temperature is higher than the predetermined value. And, if the surface temperature of the steam tank (200) falls down below another predetermined value, the temperature sensor (720) controls to supply power to the heating device (210). Therefore, with the above structures, the problem of fire damage to the user or the device by overheating or malfunction can be prevented.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A steam generator for sauna device enabling a steam sauna in a sauna room, the steam generator comprising:
a water tank for storing water;
a steam tank comprising a heating device installed so as to heat water inside and generate steam and a steam releasing hole provided so as to supply the generated steam to an external sauna room;
a connecting tube installed between the water tank and the steam tank for providing a path for water flowing from the water tank to the steam tank; and
an air pressure equalizing tube installed between the water tank and the steam tank so as to provide a path for the steam in the steam tank to move into water of the water tank and equalizing air pressure of the steam tank and the water tank.

2. The steam generator of claim 1, further comprising:
a water level sensor installed in the water tank for measuring water level;
a water supplying tube connected to the water tank for supplementing water in the water tank and installed with a first electronic opening/closing valve so as to cooperate with the water level sensor and control electronically water flow into the water tank; and
a venting tube installed in the water tank so as to provide a path for venting air in the water tank to outside and installed with a second electronic opening/closing valve so as to cooperate with the water level sensor and control electronically air flow from the water tank.

3. The steam generator of claim 2, further comprising a temperature sensor installed in the steam tank so as to be positioned in the water level of the steam tank corresponding to the water level of the water tank.

4. The steam generator of claim 2, further comprising:
a steam delivering tube extending from the steam releasing hole;
a steam disperser connected to the steam delivering tube and comprising a steam-emitting surface tilting upward; and
a water supply installed in a lower portion of the steam disperser such that the water condensated through the steam-emitting surface falls down and is retrieved, and connected to the water tank by means of the water supplying tube to supplement water.

5. The steam generator of claim 2, wherein the steam disperser and the water supply are formed in a body.

6. The steam generator of claim 5, wherein a checking transparent window is installed in the steam disperser such that the user can check the level of water stored in the water supply with naked eyes.

7. The steam generator of claim 1, further comprising:
a water level sensor installed in the water tank for measuring water level;
a water supplying tube connected to the water tank for supplementing water in the water tank and installed with a water pump so as to cooperate with the water level sensor and control electronically water flow into the water tank; and
a venting tube installed in the water tank so as to provide a path for venting air in the water tank to outside and installed with a second electronic opening/closing valve so as to cooperate with the water level sensor and control electronically air flow from the water tank.

8. The steam generator of claim 7, further comprising:
a steam delivering tube extending from the steam releasing hole;
a steam disperser connected to the steam delivering tube and comprising a steam-emitting surface tilting upward; and
a water supply installed in a lower portion of the steam disperser such that the water condensated through the steam-emitting surface falls down and is retrieved, and connected to the water tank by means of the water supplying tube to supplement water.

9. The steam generator of claim 7, wherein the steam disperser and the water supply are formed in a body.

10. The steam generator of claim 9, wherein a checking transparent window is installed in the steam disperser such that the user can check the level of water stored in the water supply with naked eyes.

11. The steam generator of claim 7, further comprising a temperature sensor installed in the steam tank so as to be positioned in the water level of the steam tank corresponding to the water level of the water tank.

12. The steam generator of claim 11, further comprising:
a steam delivering tube extending from the steam releasing hole;
a steam disperser connected to the steam delivering tube and comprising a steam-emitting surface tilting upward; and
a water supply installed in a lower portion of the steam disperser such that the water condensated through the steam-emitting surface falls down and is retrieved, and connected to the water tank by means of the water supplying tube to supplement water.

13. The steam generator of claim 12, wherein the steam disperser and the water supply are formed in a body.

14. The steam generator of claim 13, wherein a checking transparent window is installed in the steam disperser such that the user can check the level of water stored in the water supply with naked eyes.
